(19) United States
(12) Patent Application Publication
(10) Pub. No.: US 2022/0274874 A1
(43) Pub. Date: Sep. 1, 2022

(54) PROCESS FOR PRODUCING A PORE-CONTAINING GRANULATE AND A PORE-CONTAINING ARTIFICIAL STONE

(71) Applicant: REKERS GMBH MASCHINEN- UND ANLAGENBAU, Spelle (DE)

(72) Inventor: Klaus DAMBAUER, Eugendorf (AT)

(21) Appl. No.: 17/636,771

(22) PCT Filed: Aug. 13, 2020
(86) PCT No.: PCT/EP2020/072737

§ 371 Date: Feb. 18, 2022

(30) Foreign Application Priority Data
Sep. 4, 2019 (DE) 10 2019 213 457.2

(51) Int. Cl. C04B 18/02; C04B 38/10; C04B 28/04; C04B 14/06; C04B 20/00

(52) U.S. Cl. CPC C04B 18/027; C04B 38/10; C04B 28/04; C04B 14/068; C04B 20/004; C04B 2111/40

(57) ABSTRACT

The present invention relates to a process for producing a pore-containing granulate, comprising the following steps: a) producing a foamed mass using sand, hydraulic binder, foaming agent and water, b) pouring the foamed mass into a filling mould, c) partially curing the mass over a first period of time at ambient pressure to form a green block having a first target strength, and d) demoulding the green block, the process comprising the further steps e) splitting the green block into at least two sub-blocks, l) further curing the sub-blocks over a second period of time at ambient pressure until a second target strength is reached and g) breaking the sub-blocks to form pore-containing granulate with a desired particle size distribution. Furthermore, the present invention relates to a process for the production of a pore-containing artificial stone which contains the granulate as an additive.

The present invention relates to a process for the production of a pore-containing granulate, comprising the production of a foamed mass using sand, hydraulic binder, foaming agent and water, the filling of the foamed mass into a filling mould, partial curing of the mass over a first period of time at ambient pressure to form a green block with a first target strength and the demoulding of the green block. An advantageous use of the granulate produced in this way is as an additive in the production of artificial stone. Therefore, the present invention also relates to a process for the production of a pore-containing artificial stone which contains the granulate as an additive.

Granules are often used as additives in the production of artificial stone. Of particular interest in this respect is artificial stone in the field of lightweight building materials. Hereby air inclusions in the artificial stone can be created by adding granules containing pores or directly in the artificial stone itself. The present invention, however, concerns the first mentioned.

A well-known natural additive with pores is pumice. Artificially produced pore-containing granulates known in the art are expanded clay or expanded shale. Expanded clay and expanded shale are very expensive to produce and are energy-intensive due to burning and expanding at a temperature of above 1000° C. In addition, corresponding artificial stone products have a high water absorption. The shrinking behaviour is also a problem.

Pumice, on the other hand, is a natural product and only occurs in certain regions, so that it has to be imported at high cost by many countries. In addition, pumice varies in its bulk density due to natural expansion, which is problematic for products that comply with standards.

A further developed known and artificially produced granulate can be obtained by granulating foamed concrete, as described in patent specification AT 412 210 B. This allows a light, pore-containing granulate to be obtained with low production costs, which is suitable as an additive. The disadvantage of the granulate, however, is that it must be coated several times with a sand-cement slurry to close the external pores. As a further disadvantage, it has been found that when the foamed concrete is broken into granules, a considerable proportion of fine grains is produced, that cannot be used further, which increases costs.

The objective of the present invention is therefore to at least partially overcome the disadvantages mentioned above and to find cost-effective and reliable ways to produce advantageous granulates inter alia for the production of concrete products.

In order to solve the aforementioned problem, the present invention provides as a first aspect a process for the production of a pore containing granulate comprising the following steps:
a) producing a foamed mass using sand, hydraulic binder, foaming agent and water,
b) pouring the foamed mass into a filling mould,
c) partially curing the mass over a first period of time at ambient pressure to form a green block with a first target strength, and
d) demoulding the green block.

According to the invention, the process further comprises the steps:
e) splitting the green block into at least two sub-blocks,
f) further curing the sub-blocks over a second period of time at ambient pressure until a second target strength is reached, and
g) breaking the sub-blocks to form the pore-containing granulate with a desired particle size distribution.

The granulate produced by the process according to the invention exhibits particularly good heat and sound insulating properties. The two-stage comminution step according to the invention and the further hardening of the material in the meantime results in the great advantage that a considerably lower fine grain fraction, which is regarded as scrap, is produced overall compared to the previously known processes. The different hardening kinetics caused by this procedure is of decisive importance, since the rough sub-blocks cure faster than the green block. The subsequent breaking of the sub-blocks then results in a surprisingly low amount of fine grain.

In addition, it was found that the coating of the granulate, which is still explicitly required in AT 412 210 B, is not absolutely necessary and that omitting the coating even has advantages with regard to the bonding of the granulate to the substrate matrix in artificial stone.

Further advantages of the granulate produced according to the invention concern sustainability. The process enables the production of the light, very well insulating granulate without thermal production energy/firing, no CO₂ emissions. There is no need for recultivation of mining areas, as is the case with pumice stone, for example. For the production of the granulate, naturally occurring sands are used. However, fine sands, which are produced after crushing rocks and otherwise have to be returned at high costs, can also be used. In desert regions dune sand, which is sufficiently available there, can be used. This sand cannot be used for concrete production to date, but it can be used without restriction in the process according to the invention. This means that the so-called “sea sand theft”, which is problematic in Asian and African regions, can be reduced, or even stopped.

Furthermore, the granulate produced according to the invention can be used in bulk as a highly insulating and air-permeable building material. This results in energy savings in buildings (air conditioning/heating costs) as well as a healthy room and house climate through the breathability of the wall.

The production of a foamed mass according to the invention using sand, hydraulic binder, foaming agent and water can be done in different ways. According to a preferred embodiment, a foam is first produced with the foaming agent and water, which is then mixed with or preferably submerged under a mixture of sand, hydraulic binder and, if necessary, additional water. However, the hydraulic binder can also be included in the foam making process, so that a slurry of foam and hydraulic binder is finally mixed with sand or a sand/water mixture.

The foaming agents to be used in the process according to the invention are known to the skilled person, for example from the production of conventional foamed concrete. These consist essentially of surfactants and proteins. The choice of the foaming agent is not particularly limited.

During the foaming process, the volume of the initial mixture is preferably increased by a factor of 6 to 8. Foaming is achieved by known methods, for example by means of a foam gun.

According to a further preferred embodiment of the process according to the invention, the first period of time of the curing is shorter than the second period of time of the curing.

Preferably, the first period of time of the curing is 5 to 36 hours, further preferably 8 to 32 hours, still further preferably 16 to 24 hours. The first period of time of the curing can be varied depending on the size of the mould chosen for the green block.

Further preferred is a second period of time of the curing of 4 to 10 days, preferably 6 to 8 days.

In accordance with a preferred embodiment of the process according to the invention, the partial curing of the mass in step c) is carried out in a dry atmosphere.

According to a preferred embodiment of the process according to the invention, the sub-blocks obtained in step e) have an average volume of 1 dm3 to 100 dm3.

According to a preferred embodiment of the process according to the invention, the further curing of the sub-blocks in step f) is carried out at ambient temperature and ambient humidity. It is preferable to ensure that the partial blocks do not become wet. If the partial blocks are stored outdoors, protection against rain should be provided.

In accordance with a preferred embodiment of the process according to the invention, the breaking of the cured sub-blocks to form the pore-containing granulate in step g) is carried out with oversize grain return. This increases the proportion of the desired grain size fraction. In a manner known to the expert, broken grain of still too coarse grain size is fed back into the crushing process. The final grain size or grain size distribution is not particularly limited and can vary depending on the type of use. Preferred grain size fractions are 0.5 to 2 mm, 2 to 6 mm and 6 to 12 mm.

The choice of sand to be used is not particularly limited. According to a preferred embodiment of the process according to the invention, the sand used to produce the foamed mass comprises desert sand, lime sand, quartz sand, diabase sand, gabbro sand and/or basalt sand.

According to a preferred embodiment of the process according to the invention, the hydraulic binder used to produce the foamed mass comprises cement, preferably Portland cement. Suitable types of cement can be selected by the skilled person according to the intended area of use of the granulate. Preferred types are for example CEM I 42.5 R/N and CEM I 52.5 R/N.

According to a preferred embodiment of the process according to the invention, stone meal, filter dust, slag and/or fly ash are further used to produce the foamed mass. Other advantageous additives are fibres, such as insulating wool, and absorbers.

According to a preferred embodiment of the process according to the invention, the filling mould used in step b) is filled with the foamed mass up to a maximum height of 100 cm, preferably 60 cm. If the filling height is too high, the pores can be distributed very unevenly in the material due to the strong pressure gradient.

The present invention provides, as a second aspect, a process for the production of a pore-containing artificial stone, which is carried out by using as an additive a granulate produced according to one of the above mentioned embodiments according to the invention or, respectively, one of the preferred embodiments. In the simplest case, the granulate is mixed together with the still liquid concrete in a concrete mixer.

The artificial stone obtained according to the invention has a number of advantages in view of the known pore-containing artificial stones, such as aerated concrete or cellular concrete. Aerated concrete or cellular concrete, for example, are produced in a complex and energy-intensive process using autoclaving. The semi-finished raw blocks are usually hardened at 190° C. under a pressure of 12 bar for approx. 16 hours under steam in an autoclave. On the one hand, the product costs are very high, on the other hand, the aerated concrete can only be used for selected applications, for example due to the achievable strengths and thermal insulation values as well as the water absorption.

Furthermore, the dimensions of the producible products are limited by the production process. For this reason, there are no prefabricated concrete elements in larger dimensions on the market to date, such as wall elements made of lightweight concrete. However, with the granulate according to the invention, in addition to concrete blocks in standard dimensions, large-scale prefabricated elements with dimensions of more than 1 m by 1 m, for example for walls, can be produced cost-effectively and reliably.

According to a preferred embodiment of the process according to the invention, a lightweight concrete artificial stone, lightweight concrete component and/or a large-scale lightweight concrete prefabricated element is produced with the process.

In the context of the present invention, the term artificial stone comprises mineral- or resin-bonded compounds which are produced with additives of, for example, sand, crushed rock or another comparable crushed grain or granulate. Artificial stone is also to be understood as a processed liquid concrete which has been brought into any form, such as concrete walls or floors that are cast on a building site.

A large-scale prefabricated element refers to components such as a wall. In general, a large-scale prefabricated element can therefore be understood as one with minimum dimensions of 1 m by 1 m.

There is no particular limitation as to which strength falls under the terms first and second target strength. Because, as the term target strength already expresses, the determination of the target, i.e. the strength to be achieved, lies within the competence of the respective skilled person carrying out the process. However, the first target strength should be chosen large enough to ensure that the green block does not fall apart during demoulding.

In the context of the present invention, ambient pressure means the pressure present in the environment, i.e. that no measures to change the pressure, such as autoclaving, are necessary.

Accordingly, the terms ambient temperature and ambient humidity are to be understood as the temperature or humidity present in the environment. The environment can also preferably be outdoors, i.e. outside buildings.

In the context of the present invention, dry atmosphere means an atmosphere with an air humidity which is low enough that water contained in the green block evaporates. A suitable drying atmosphere can be created and maintained, for example, by drying chambers known to the skilled person.

Splitting the green block means, inter alia, breaking and/or cutting the green block to an intermediate size. This increases the surface of the green block material, which accelerates the drying and further curing of the material. Another surprising advantage, as described above, is also that the final breaking down to the desired grain size produces significantly less fines.

The process of the present invention can be exemplarily carried out in such a way that fine sand is foamed to 6-8 times its volume with water, hydraulic binder and surfactants, stored and then crushed in 2 steps and screened into corresponding grain size fractions. The resulting granulate can be used as a light-weight additive for the concrete industry in a wide range of applications.

Fine sand, water and cement are mixed. A surfactant is added to the mixture by means of a foam gun until a creamy mass with a pore content of about 80% is obtained.

This is followed by discharging, conveying and partial curing. The mixture is then appropriately emptied into tubs, which can be temporarily stored, for example in a rack system, to save space and allow the mass to cure in advance. The way of the filling of the tubs and the geometrical shape and height of the tub have a considerable effect on the properties of the cured mass. Also from an economic point of view, the dimensions of the tub in this embodiment are 2500 mm to 3000 mm with a height of 600 mm.

After being stored in the curing chamber, which is a drying chamber, the tubs are removed from the chamber, for example, by means of a transport trolley and brought to the demoulding station. In the first step, one full tub after the other can be fixed with a turning device and in a second step it can be turned and for instance tilted onto a demoulding table so that the cured foam mass is released from the tub.

In the next step, the demoulded foam cake is pre-crushed or cut into sub-blocks by a crushing unit. The sub-blocks are temporarily stored for about one week, during which time they continue to cure. During this time, the hydraulic curing process ensures that the sub-blocks achieve the required strength so that the pre-crushed sub-blocks can then be crushed with a standard crushing unit to produce the granulate.

This granulate is an intermediate product which can now be used for a wide range of applications, especially as an additive for the production of concrete blocks (e.g. heat-insulating masonry blocks).

In addition, it can also be used for heat-insulating plasters and mortars, lightweight concrete with high strength and high thermal insulation, for thermal insulation in the uppermost floor ceilings in a building, for fillings under floors, for filling material in the geotechnical sector or for noise barriers.

The granulate is particularly suitable for large-scale prefabricated elements of lightweight concrete. The density of artificial stone produced with the granulate can be adjusted to 350 kg/m³ up to 900 kg/m³, depending on the relative amount of the granulate.

1. A process for preparing a granulate containing pores, comprising the following steps:
a) producing a foamed mass using sand, hydraulic binder, foaming agent and water,
b) pouring the foamed mass into a filling mould,
c) partially curing the mass over a first period of time at ambient pressure to form a green block with a first target strength; and
d) demoulding the green block,
characterised in that
the process comprises the following further steps:
e) splitting the green block into at least two sub-blocks,
f) further curing of the sub-blocks over a second period of time at ambient pressure until a second target strength is reached, wherein the first period of time of the curing is shorter than the second period of time of the curing; and
g) breaking the sub-blocks to form the pore-containing granulate with a desired particle size distribution.

2. (canceled)

3. The process according to claim 1,
characterised in that
the first period of time of the curing is 5 to 36 hours.

4. The process according to claim 1,
characterised in that
the second curing period is 4 to 10 days.

5. The process according to claim 1,
characterised in that
the partial curing of the mass in step c) is carried out in a dry atmosphere.

6. The process according to claim 1,
characterised in that
the sub-blocks obtained in step e) have an average volume of 1 dm³ to 100 dm³.

7. The process according to claim 1,
characterised in that
the further curing of the sub-blocks in step f) is carried out at ambient temperature and ambient humidity.

8. The process according to claim 1,
characterised in that
the breaking of the cured sub-blocks into the pore-containing granulate of step g) is carried out with oversize grain return.

9. The process according to claim 1,
characterised in that
the sand used to produce the foamed mass comprises desert sand, lime sand, quartz sand, diabase sand, gabbro sand and/or basalt sand.

10. The process according to claim 1,
characterised in that
the hydraulic binder used to produce the foamed mass comprises cement.

11. The process according to claim 1,
characterised in that
further using stone meal, filter dust, slag and/or fly ash for the production of the foamed mass.

12. The process according to claim 1,
characterised in that
the filling mould used in step b) is filled with the foamed mass up to a maximum height of 100 cm.

13. A process for the production of a pore-containing artificial stone,
characterised in that
the process is carried out by using as an additive a granulate produced according to claim 1.

14. The process according to claim 13,
characterised in that
the process is used to produce a lightweight concrete artificial stone, lightweight concrete component and/or a large-scale lightweight concrete prefabricated element.

15. The process according to claim 1,
characterised in that
the first period of time of the curing is 8 to 32 hours.

16. The process according to claim 1,
characterised in that
the first period of time of the curing is 16 to 24 hours.

17. The process according to claim 1,
characterised in that
the second curing period is 6 to 8 days.

18. The process according to claim 10,
characterised in that
the hydraulic binder used to produce the foamed mass comprises Portland cement.

19. The process according to claim 1,
characterised in that
the filling mould used in step b) is filled with the foamed mass up to a maximum height of 60 cm.
